(19) United States
(12) Patent Application Publication
(10) Pub. No.: US 2026/0110606 A1
(43) Pub. Date: Apr. 23, 2026

(54) SUBLIMATION APPARATUSES AND METHODS OF MAKING AND USING THE SAME

(71) Applicant: HTX Technologies, LLC, Chapel Hill, NC (US)

(72) Inventors: Alain J. Creissen, Chapel Hill, NC (US); Alyson Black, Carrboro, NC (US); Stephen Henley, Carrboro, NC (US)

(21) Appl. No.: 19/367,041

(22) Filed: Oct. 23, 2025

Related U.S. Application Data
(60) Provisional application No. 63/710,838, filed on Oct. 23, 2024.

(51) Int. Cl. G01N 1/40

(52) U.S. Cl. CPC G01N 1/4022

(57) ABSTRACT

Disclosed herein are devices and methods of making and using devices for sublimation. In one embodiment, an apparatus for performing sublimation is disclosed. The apparatus includes a lower assembly with a heat source, an upper assembly with a heat exchange core, and a hinge assembly mechanically coupling the lower assembly to the upper assembly. The apparatus is configured for allowing a substrate to be positioned within an interior chamber of the upper assembly when in an open position, facilitating deposition of a material onto the substrate via sublimation when in a closed position, and allowing removal of the substrate with the material when returned to the open position.

### CROSS-REFERENCE TO RELATED APPLICATIONS

This application claims priority to U.S. Provisional Application No. 63/710,838, titled “SUBLIMATION APPARATUSES AND METHODS OF MAKING AND USING THE SAME,” filed Oct. 23, 2024, the entire content of which is hereby incorporated by reference herein.

### TECHNICAL FIELD

This disclosure generally relates to the deposition of chemicals onto a substrate via sublimation. More specifically, apparatuses are disclosed for sample preparation for mass spectrometry imaging. Additionally, methods of making and using the apparatuses are also disclosed.

### BACKGROUND

While various spray assemblies have been developed for coating a planar surface, the desire for enhanced quantitative and qualitative controls of chemical deposition continues to exist. Sublimation deposition offers an improved alternative to spraying. Sublimation is the conversion of a substance directly from a solid state to a gaseous state or from a gaseous state to a solid state without becoming a liquid. Each substance has conditions for sublimation that can occur with a specific pressure and temperature relationship. Commonly, vacuum levels of pressure are used for sublimation to occur, as this lowers the temperature necessary to achieve sublimation of a substance. Sublimation is possible with many substances under the correct vapor pressure and temperature relationships. A use of sublimation is to avoid the transition of a substance to a liquid where the presence of a liquid can have an impact on the results. For example, sublimation (from gaseous state to solid state) can provide a better alternative to spraying (from liquid to solid state) a material on to a substrate to achieve a more uniform coating.

As such, improved devices and methods are needed to perform a variety of applications for sublimation.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are devices and methods of making and using devices for sublimation. In one embodiment, an apparatus for providing sublimation is disclosed. The apparatus includes a lower assembly, an upper assembly, and a hinge assembly mechanically coupling the lower assembly to the upper assembly. The apparatus is configured for allowing a substrate to be positioned within an interior chamber when in an open position, facilitating deposition of a material onto the substrate via sublimation when in a closed position, and allowing removal of the substrate with the material when returned to the open position.

In another embodiment, a method for operating an apparatus for providing sublimation is disclosed. The method includes configuring the apparatus to be in an open position and positioning a substrate within an interior chamber of the apparatus. The method further includes configuring the apparatus to be in a closed position with the substrate within the interior chamber and adjusting a pressure and a temperature of the interior chamber for sublimation of a material onto the substrate. The method still further includes configuring the apparatus to be in the open position and removing the substrate from the interior chamber of the apparatus.

In another embodiment, a method of manufacturing an apparatus for providing sublimation is disclosed. The method includes mechanically assembling a lower assembly, mechanically assembling an upper assembly, mechanically coupling the lower assembly to the upper assembly using a hinge assembly. The apparatus is configured for allowing a substrate to be positioned within an interior chamber when in an open position, facilitating deposition of a material onto the substrate via sublimation when in a closed position, and allowing removal of the substrate with the material when returned to the open position.

### BRIEF DESCRIPTION OF THE DRAWINGS

The present embodiments are illustrated by way of example and are not intended to be limited by the figures of the accompanying drawings. In the drawings:

FIG. 1 depicts a mechanical diagram illustrating an open position of an apparatus for sublimation including a lower assembly and an upper assembly in accordance with embodiments of the present disclosure.

FIG. 2 depicts a mechanical diagram illustrating a closed position of the apparatus of FIG. 1 in accordance with embodiments of the present disclosure.

FIG. 3 depicts a mechanical diagram illustrating a cut away side view of the lower assembly of FIG. 1 in accordance with embodiments of the present disclosure

FIG. 4 depicts a mechanical diagram illustrating the lower assembly of FIG. 1 and further illustrating a heat source within the lower assembly in accordance with embodiments of the present disclosure.

FIG. 5 depicts a mechanical diagram illustrating a direct contact plate positioned in the lower assembly of FIG. 1 in accordance with embodiments of the present disclosure.

FIG. 6 depicts a mechanical diagram illustrating a cut away side view of the upper assembly of FIG. 1 in accordance with embodiments of the present disclosure.

FIG. 7 depicts a mechanical diagram illustrating another embodiment of the lower assembly of FIG. 1 and further illustrating a heat source located outside of the vacuum chamber in accordance with embodiments of the present disclosure.

FIG. 8 depicts a mechanical diagram illustrating a matrix funnel positioned in the lower assembly of FIG. 1 in accordance with embodiments of the present disclosure.

FIG. 9A through FIG. 9C depict a mechanical diagrams illustrating a sample mask for securing samples directly to a heat exchange core of the upper assembly in accordance with embodiments of the present disclosure.

FIG. 10 depicts a flowchart illustrating a method of using the apparatus of FIG. 1 in accordance with embodiments of the present disclosure.

FIG. 11 depicts a flowchart illustrating a method for manufacturing the apparatus of FIG. 1 in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Disclosed herein are devices and methods of making and using devices for chemical deposition onto a substrate via sublimation. More specifically, the sublimation may be used for sample preparation for mass spectrometry imaging. Further this chemical deposition may be used for matrix-assisted laser desorption/ionization mass spectrometry imaging (MALDI MSI). Mass spectrometry imaging is a technique for the spatial analysis of analytes within samples, such as the distribution of drugs, lipids, metabolites, proteins, peptides and other small molecules. The quality of the spatial analysis can be related to the quality of the matrix deposition onto a substrate, and in particular to the matrix crystal sizes that are formed during deposition.

Sublimation, as described, is a technique that can be employed to deposit MALDI matrix onto a substrate with the potential for small crystal sizes due to the lack of liquid used in the process. This process requires the use of vacuum and temperature gradient to move the matrix chemicals onto the substrate/sample. For example, an underlying substance or layer can be a substrate. In the technical field of this application, samples are commonly glass microscope slides or metal target plates containing biological material such as tissues or cells. The ability to control the temperature gradient via both matrix heating and sample cooling improves the quality and reproducibility of matrix deposition for MALDI MSI analysis. In addition, the ability to deposit matrix across a larger area/more samples improve the throughput of this technique in laboratories.

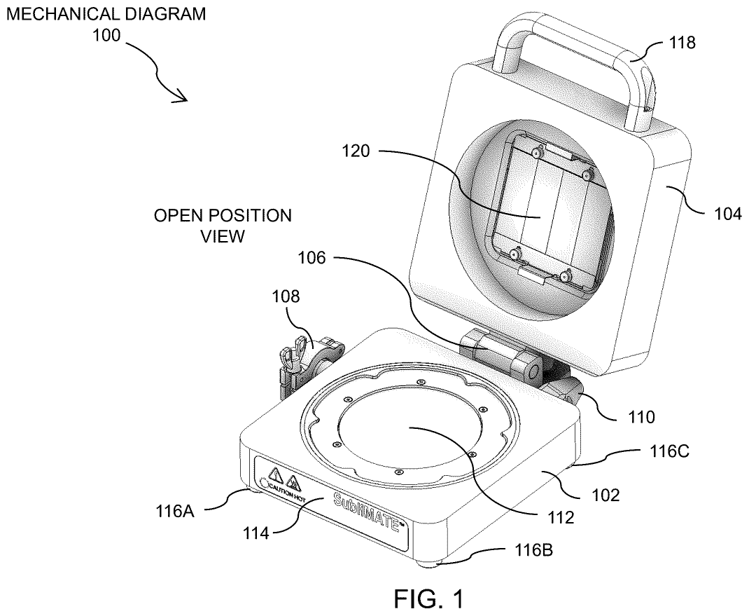

FIG. 1 depicts a mechanical diagram 100 illustrating an open position for one embodiment of an apparatus for sublimation including a lower assembly 102 and an upper assembly 104 in accordance with embodiments of the present disclosure. The apparatus includes a lower assembly 102 and an upper assembly 104 mechanically coupled via a hinge assembly 106. The lower assembly 102 includes a vacuum inlet 108 configured for attachment to a vacuum pump, alternatively the upper assembly 104 could include a vacuum inlet. The lower assembly 102 further includes a plurality of sensors (not shown in FIG. 1) accessible via an electrical interconnect 110. The lower assembly also includes a heat source 112 that is electrically coupled via the electrical interconnect 110. The lower assembly further includes a label 114 and a plurality of non-skid feet 116A-116D (non-skid foot 116D is not shown in FIG. 1). The upper assembly 104 includes a handle 118 for configuring the apparatus in one of an open state or a closed state. Alternately, the hinge assembly may include a motor mechanism for automatically transitioning the apparatus between the open position and the closed position without the need for the handle 118. The upper assembly 104 is configured to provide an internal chamber and includes a sample holder 120. The sample holder 120 is configured to hold a plurality of slides (e.g., glass microscope slides) or one of more metal target plates for matrix sublimation.

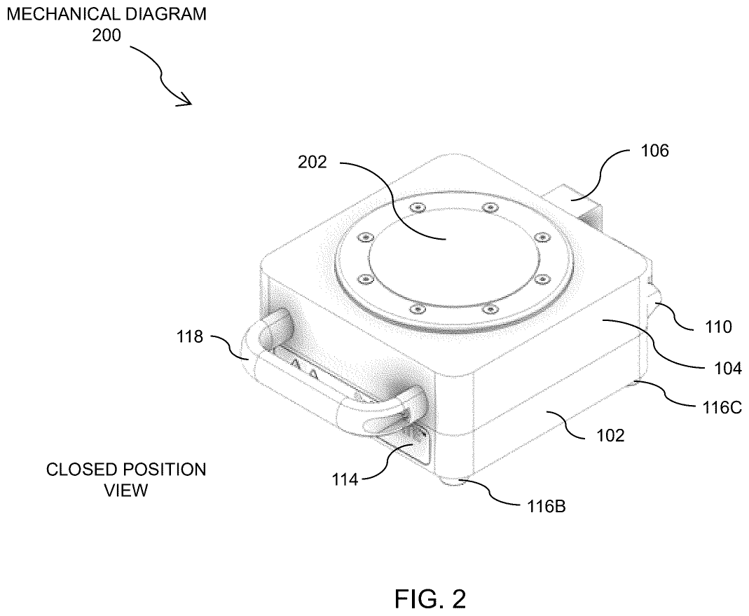

FIG. 2 depicts a mechanical diagram 200 illustrating a closed position of the apparatus of FIG. 1 in accordance with embodiments of the present disclosure. The upper assembly 104 includes a heat exchange core 202. The heat exchange core 202 may be an isolated solid metal block extending from the interior chamber to the exterior and acts as a heat sink when cooled with various coolants. Additionally, the heat exchange core 202 may be configured to be thermally coupled with a thermoelectric cooler (e.g., a Peltier cooler). Alternately, the heat exchange core 202 may be configured to be thermally coupled with an external heatsink configured for force air heat transfer (e.g., a fan) or with the various liquid coolants via a separate radiator assembly.

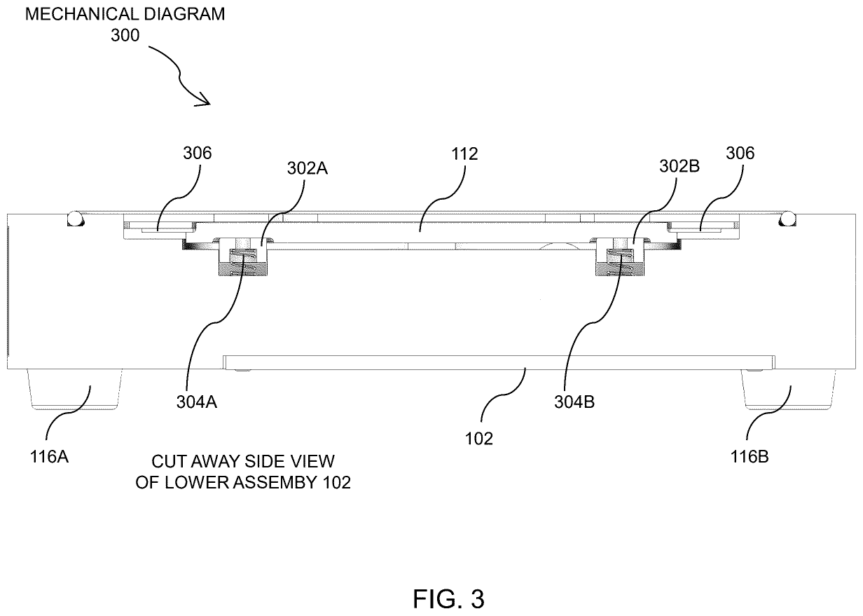

FIG. 3 depicts a mechanical diagram 300 illustrating a cut away side view of the lower assembly 102 of FIG. 1 in accordance with embodiments of the present disclosure. The lower assembly 102 includes washers 302A-302B and springs 304A-304B that provide isolation of a bottom side of the heat source 112 from the case of the lower assembly 102. Additional washers and springs (not shown in FIG. 3) provide additional thermal isolation and support for the bottom side of the heat source 112 from the case of the lower assembly 102. The lower assembly also includes a gasket 306 that provides additional isolation of the top side of the heat source 112 from the diffusing plate 402 and the surrounding lower assembly 102.

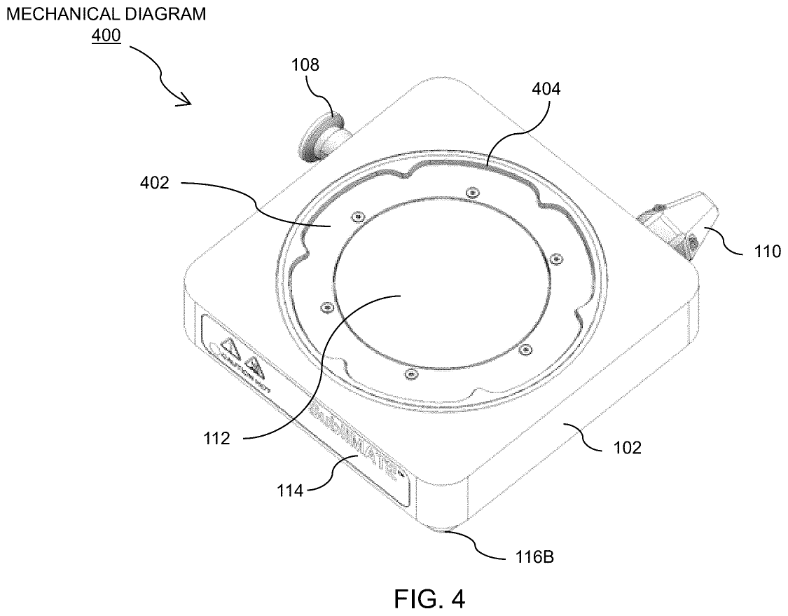

FIG. 4 depicts a mechanical diagram 400 illustrating the lower assembly of FIG. 1 and further illustrating the heat source 112 and a diffusing plate 402 within the lower assembly 102 in accordance with embodiments of the present disclosure. In this embodiment, the diffusing plate 402 is a thin plate of metal fixed in the lower assembly 102 to hold the heat source 112 in position and distribute air flow via gap 404. A gap 404 isolates the diffusing plate 402 from the case of the lower assembly 102.

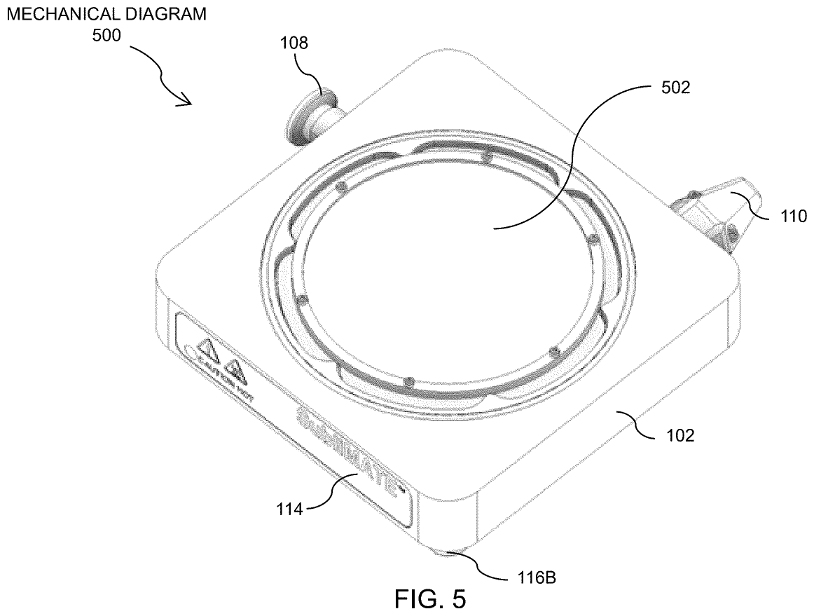

FIG. 5 depicts a mechanical diagram 500 illustrating some embodiments of the apparatus where a direct contact plate 502 positioned in the lower assembly 102 and above the heat source 112 of FIG. 1 in accordance with embodiments of the present disclosure. The direct contact plate 502 is a fixed vessel for holding matrix to be heated during sublimation. The direct contact plate 502 is attached in direct contact with the heat source 112. A wafer may be used instead of the direct contact plate 502. The wafer is a removeable patterned template also containing matrix to be heated via the heat source 112 during sublimation.

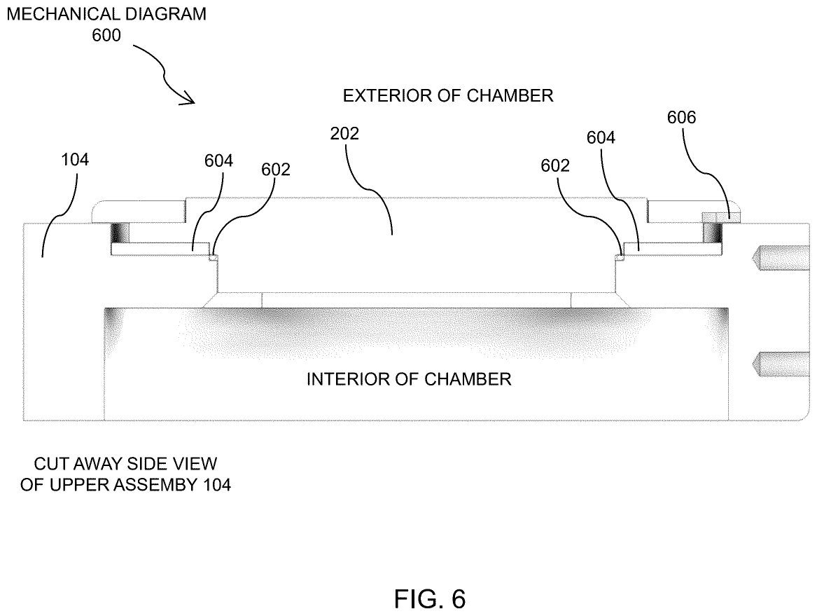

FIG. 6 depicts a mechanical diagram 600 illustrating a cut away side view of the upper assembly 104 of FIG. 1 in accordance with embodiments of the present disclosure. The upper assembly 104 further includes an O-ring 602 for maintaining vacuum and thermally isolating the case of the upper assembly 104 from the heat exchange core 202. Additionally, an air gap 604 provides further thermal isolation of the case of the upper assembly 104 from the heat exchange core 202. The upper assembly 104 further includes a drain 606 for removing or preventing condensation within the air gap 604

The previously described apparatus of FIG. 1 through FIG. 6 overcomes many limitations of currently available sublimation apparatuses including the issues described in the following paragraphs.

Issue one, the heat distribution source is limited in size (usually less than 2,000 square millimeters) preventing uniform coating of a large sample area/multiple substrates.

Issue two, the ultimate temperature of the heat source is limited due to the heater technology (e.g., heater cartridge, heater film, convection, etc.). The maximum temperature is typically limited to 250 degrees Celsius.

Issue three, the chamber lower assembly can become very hot requiring long cooling times before opening and resulting in possibly unsafe operation.

Issue four, uneven contact surfaces between heater and wafer can create space that under vacuum becomes a significant insulative barrier, thus limiting the ultimate temperature attained by the matrix.

Issue five, vacuum is typically pulled from the top of the chamber which creates a very cumbersome upper assembly that takes time to disconnect and move away from the lower assembly, reducing the speed and ease of retrieving the substrate and/or sample holder.

Issue six, vacuum draft can be substantial inside the chamber and a large matrix deposit layer may be deposited on the inside wall of the chamber.

Issue seven, wafer size is limited due to the size of the heater. In some cases a larger area of matrix coating is beneficial to allow the coating of more samples for higher throughput and more complete coverage to reduce edge effects.

Issue eight, cooling with liquid coolant typically requires additional tubing for either circulation of a cooled liquid for drainage of a melting solid/liquid mixture. Tubing adds complexity to use and requires additional space.

Issue nine, cooling at ultra-low temperatures (e.g., −78 degrees Celsius with dry ice/acetone mixture) creates issues with the upper assembly of sublimation chambers. When using glass for the fabrication of the chamber, temperature cycling between ambient and −78 degrees Celsius can cause accelerated cracking and failure. When using aluminum or other metal, the upper assembly and lower assembly can frost over due to the higher heat conductivity of metals.

Issue ten, the previously described frost can extend to connectors and electrical connections and reduce their lifespan. The frost also makes the assembly difficult to safely handle. This requires special gloves and extended temperature equilibration time to return to ambient temperature.

Issue eleven, distances as much as ten to twenty centimeters between heat source with matrix vessel and substrate (and sample holder) can lead to increased matrix consumption due to loss to surrounding surfaces.

The previously described apparatus of FIG. 1 through FIG. 6 and other similar embodiments offer many improvements over the above limitations. These improvements are described in the following paragraphs.

In general, the heat source has a surface area greater than 2,000 square millimeters, allowing for a large wafer or direct contact plate to be heated quickly and consistently. The larger size matrix vessel results in increased sample area for sublimation and increases the sample throughput. In the currently described embodiment, the heat source has a surface area greater than 10,000 square millimeters and the heat source is circular in shape. In other embodiments the heat source may be square or rectangular in shape and may vary in sizes smaller than 10,000 square millimeters.

In the currently described embodiment, the heat source is a ceramic heater capable of up to 400 degrees Celsius and can reach temperature setpoint in at or less than 120 seconds. Alternatively, the heat source may be an infrared heater, an induction heater, a resistance heater, and/or the like.

In the currently described embodiment, the heat source is suspended inside the chassis using spring loaded posts with small area contact points and high temperature polymer gaskets. Alternatively, the heat source may be infra-red, induction or other wave energy and maybe positioned outside the vacuum chamber and heat the matrix vessel through a high silica glass porthole or other non-metallic material that efficiently conducts heat without reaching melting point or unsafe temperatures.

In the currently described embodiment, the contact points are ceramic on ceramic.

In the currently described embodiment, the contact area is less than five percent of the heater surface area

In the currently described embodiment, high temperature polymer gaskets are capable of withstanding temperatures up to 400 degrees Celsius. By suspending the heat source heat transfer to the chassis is reduced. This minimizes heat loss and focuses the energy on the wafer or the direct contact plate. Additionally, the suspension of heat source via spring loaded posts extends the lifetime of heat source by allowing the material to expand and contract with heat cycles without external forces to the heater that may lead to cracking and failure.

In the currently described embodiment, the heater is positioned less than four centimeters from the sample holder. This distance limits the amount of matrix lost to the surrounding surfaces. Alternatively the heater could be positioned greater than four centimeters from the sample holder. The wafer or vessel containing matrix may be attached to the heat source for improved heat transfer. Additionally, the wafer may be connected with thermal paste to the heater. Clamps, screws, and/or brackets may also be used to secure the wafer or vessel against the heater

In the currently described embodiment, vacuum is pulled from a channel located in the lower assembly allowing all vacuum tubing, connector and gauges to stay in place during the opening of the chamber. A hinge and handle design is implemented for fast, easy and safe opening of the chamber, even before all surfaces have returned to ambient temperature.

In the currently described embodiment, the sublimation chamber has a volume of less than 0.8 liter with a sample area capacity of at or greater than 7,500 square millimeters for 4 microscope slides.

In the currently described embodiment, a diffusing plate is inserted between the vacuum inlet, the matrix vessel, and the heat source allowing a uniform vacuum pull and limiting the loss of significant amount of matrix powder. The resulting surface also acts as a mask that protects the inside compartment of the lower assembly.

In the currently described embodiment, the diffusing plate has a flower pattern, and the center of the plate is cut in the same shape as the wafer. The diffusing plate also positions the matrix wafer to ensure consistent placement of the removeable wafer on the heat source with every sublimation cycle.

In the currently described embodiment, a permanent direct contact plate may be substituted for the wafer as a vessel for holding matrix to potentially improve heat transfer. The direct contact plate is affixed in direct contact with the heat source and is made of metal. Alternately, the direct contact plate may be made of other heat conductive materials. Alternately, the direct contact plate may be circular, rectangular, or square in shape. The direct contact plate may be larger than the surface area of heat source for increased sample area of sublimation. In the currently described embodiment, the direct contact plate has a surface area that is approximately forty percent larger than heat source and wafer. The matrix may be applied to a template by spray or other deposition technique to create consumable matrix pads that can be deposited onto the direct contact plate. Alternately, the direct contact plate may have a patterned surface or discrete wells to promote even or selective distribution of matrix across its surface.

In the currently described embodiment, the upper assembly includes a heat exchange core that is embedded in the upper assembly but also insulated from the upper assembly, and therefore from the chassis. The heat exchange core extends from the interior of the chamber where it is in contact with the sample holder to the exterior of the chamber to be in contact with a coolant.

In the currently described embodiment, the upper assembly includes an aluminum block (i.e., heat exchange core) that is centered and held in place in the chassis with a polymer spacer capable of withstanding ultra-low temperature. The material may be an ultra high molecular weight (UHMW) polyethylene or the like. The heat exchange core does not make contact with the chassis but is maintained against a silicone O-ring that is compressed when the assembly is under vacuum. The heat exchange core may include magnets to hold the sample holder or sample mask.

In the currently described embodiment, the heat exchange core is circular in shape. Alternately the heat exchange core may be rectangular or square in shape.

In the currently described embodiment, the heat exchange core surface area is larger than the sample holder, with an area greater than 10,000 square millimeters. Alternately the heat exchange core may have a surface that is smaller than the sample holder or sample mask.

The heat exchange core may have the same surface area both interior and exterior to the chamber. Alternatively, the surface areas may be different.

In the currently described embodiment, the heat exchange core has a flat surface that provides improved conductivity with the external recipient containing the coolant. Alternately a textured surface may be used to increase this surface area. The coolant may be a cooled liquid such as ice water, dry ice with acetone, liquid nitrogen, a solid heat sink, a heat exchanger connected to an external chiller, or a powered cooling device (e.g., a Peltier cooler).

In the currently described embodiment, the heat transfer efficiency of the heat exchange core, and the fact that it is insulated from the bulkier chassis, allows for minimal heat loss. As such, the substrate retaining device maintains a temperature within plus or minus ten degrees Celsius of a coolant temperature.

In the currently described embodiment, locations around the heat exchange core and the polymer spacer where minimal frosting may occur allow the user to use anti-frost liquids such as organic solvent mixture to wipe the frosting. A drain channel is included in the spacer that allows the liquid to flow safely away from electrical connectors. A similar draining channel is also included around electrical connectors and temperature sensors for similar functionality.

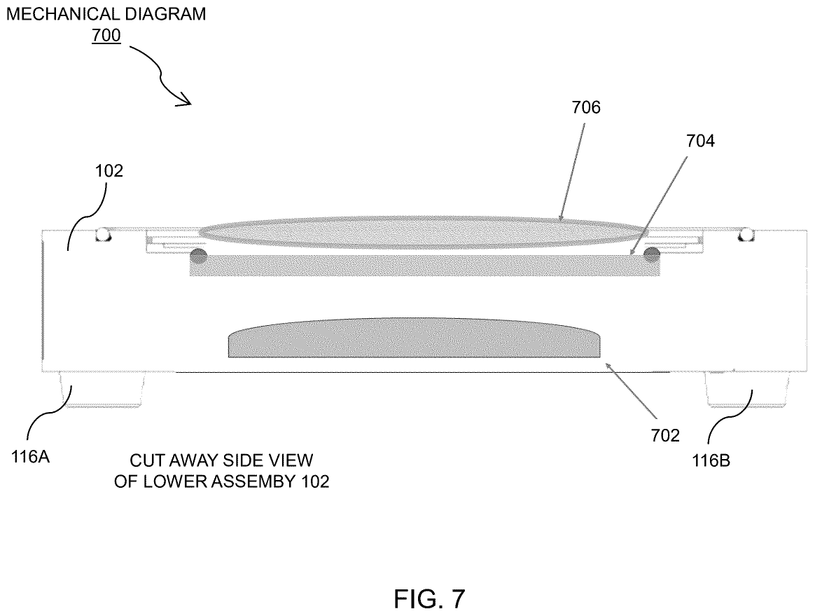

FIG. 7 depicts a mechanical diagram 700 illustrating a cut away side view of another embodiment the lower assembly 102 of FIG. 1 in accordance with some embodiments of the present disclosure. A heat source 702 (e.g., a wave energy heater) is located outside of the vacuum chamber. The lower assembly 102 includes a porthole 704 and/or other non-metallic material for heating the matrix vessel 706 via wave energy if a wave energy heater is used.

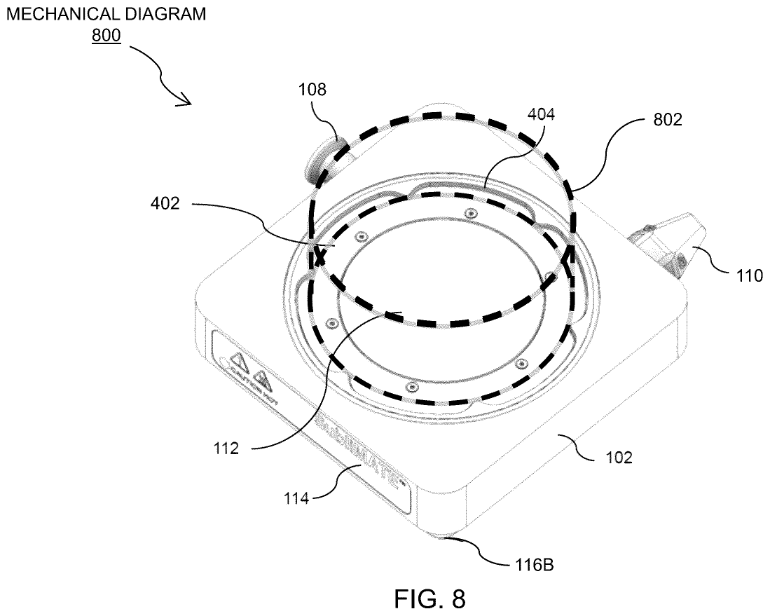

FIG. 8 depicts a mechanical diagram 800 illustrating another embodiments of the apparatus where a matrix funnel 802 is positioned in the lower assembly 102 and above the diffusing plate 402 in accordance with embodiments of the present disclosure. In this embodiment, the matrix vessel is made of polymer resin and extends from the lower assembly 102 toward the samples in the upper assembly 104, leaving a gap at the top for vacuum. The matrix funnel 802 may be made of a polymer resin, such as Polyamide, Polyimide, PEEK or other insulative high heat plastics material onto which matrix crystals will form less quickly than on colder metal surfaces.

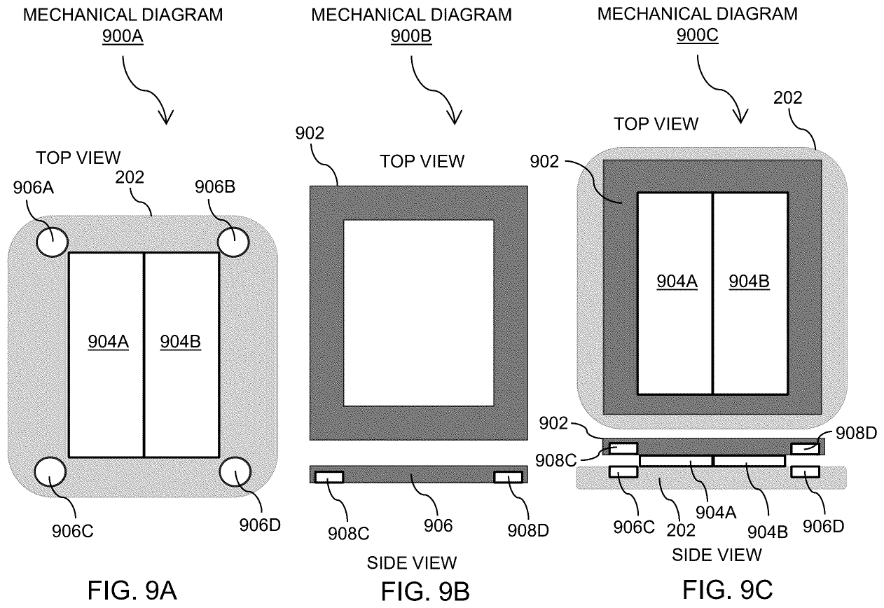

FIG. 9A through FIG. 9C depict mechanical diagrams 900A through 900C illustrating a sample mask 902 for securing sample slides 904A and 904B directly to the heat exchange core 202 of the upper assembly 104 in accordance with embodiments of the present disclosure. Mechanical diagram 900A further depicts sample slides 904A and 904B placed against the heat exchange core 202. In some embodiments, the slide capacity varies between one and four sample slides. Core magnets 906A through 906D are positioned within the heat exchange core 202 and are used for securing the sample mask 902 to the heat exchange core 202. Mechanical diagram 900B further depicts a top view and a side view of the sample mask 902 for securing the sample slides 902A and 902B against the heat exchange core 202. Mask magnets 908A through 908D are positioned within the sample mask 902 and configured to attract the sample mask 902 to the core magnets 906A through 906D respectively. Mask magnets 908A and 908B are hidden from view in mechanical diagrams 900B and 900C. Mechanical diagram 900C further depicts a top view and a side view of the magnetic mask 902 securing the slides 904A and 904B against the heat exchange core 202. In some embodiments, core magnets 906A through 906D may be omitted if the heat exchange core 202 contains ferromagnetic and/or paramagnetic material. In other embodiments, mask magnets 908A through 908D may be omitted if the sample mask 902 contains ferromagnetic and/or paramagnetic material. In further embodiments, more or less core magnets and/or mask magnets may be used.

In broader embodiments, an apparatus for providing sublimation is disclosed. The apparatus includes a lower assembly, a top assembly, and a hinge assembly mechanically coupling the lower assembly to the upper assembly. The apparatus is configured for allowing a substrate to be positioned within an interior chamber when in an open position, facilitating deposition of a material onto the substrate via sublimation when in a closed position, and allowing removal of the substrate with the material when returned to the open position.

In some embodiments, the substrate may be used in sample preparation for mass spectrometry imaging.

In some embodiments, the lower assembly may include a vacuum inlet configured for attachment to a vacuum pump.

In some embodiments, the lower assembly may further include a plurality of sensors accessible via an electrical interconnect.

In some embodiments, the lower assembly may further include a heat source electrically coupled via the electrical interconnect.

In some embodiments, the lower assembly may further include a plurality of non-skid feet.

In some embodiments, the upper assembly may be configured to provide an internal chamber when in the closed position and comprises a sample holder.

In some embodiments, the internal chamber may be approximately the shape of a cylinder.

In some embodiments, the internal chamber may be approximately the shape of at least one of a prism, a sphere, and a cone.

In some embodiments, the sample holder may be configured to hold a plurality of slides.

In some embodiments, the samples are secured directly to the heat exchange core without the use of sample holder but with a sample mask or conductive tape.

In some embodiments, the sample mask geometry allows masking of specific areas on the samples including, but not limited to, labels, calibration marks, or reference points.

In some embodiments, the plurality of slides may be one or more metal target plates.

In some embodiments, the sample holder or sample mask may be configured to hold at least one metal target plate.

In some embodiments, the upper assembly may further include a heat exchange core.

In some embodiments, the heat exchange core may be an isolated solid metal block extending from the internal chamber to an exterior of the upper assembly. and acts as a heat sink when cooled with various coolants.

In some embodiments, the heat exchange core may be configured to provide heat sinking from the internal chamber to the exterior of the upper assembly.

In some embodiments, the heat exchange core may be configured to be thermally coupled with a thermoelectric cooler.

In some embodiments, the thermoelectric cooler may be a Peltier cooler.

In some embodiments, the heat exchange core may be configured to be thermally coupled with a liquid coolant (e.g., an ice bath, a dry ice slurry, liquid nitrogen, and/or the like).

In some embodiments, the heat exchange core may be configured to be thermally coupled with a heatsink configured for force air heat transfer.

In some embodiments, the lower assembly may further include a wafer for holding a substance for sublimation.

In some embodiments, the wafer may be a removeable patterned template for holding matrix to be heated via the heat source during sublimation.

In some embodiments, the lower assembly may further include a fixed direct contact plate for holding a substance for sublimation.

In some embodiments, the direct contact plate may be in direct contact with the heat source for holding matrix to be heated via the heat source during sublimation.

In some embodiments, the direct contact plate has a patterned surface or discrete wells to improve even matrix distribution.

In some embodiments, a funnel may be used to direct matrix path from the matrix vessel to the samples.

In some embodiments the funnel may be removeable.

In some embodiments, the funnel may be made of a conductive metal.

In some embodiments, the funnel may be made of a non-conductive material.

In some embodiments, the funnel may be shaped like a cylinder.

In some embodiments, the funnel may be shaped like a cone or prism.

In some embodiments, the heat source may be configured to be electrically coupled to a temperature controller via the electrical interconnect.

In some embodiments, the heat source may be a ceramic heater configured to heat the interior chamber to a temperature of at least 260 degrees Celsius. In further embodiments, the heat source may be a ceramic heater configured to heat the interior chamber to a temperature of at least 300 degrees Celsius.

In some embodiments, the heat source may be configured to achieve a temperature setpoint in less than 120 seconds.

In some embodiments, the heat source may include infrared, induction, and/or resistance heaters.

In some embodiments, the heat source may be an infrared heater positioned outside of the vacuum chamber that transfers heat to the chamber through a non-metallic porthole.

In some embodiments, the upper assembly may further include a handle for configuring the apparatus in the open position or the closed position.

In some embodiments, the hinge assembly may include a motor mechanism for automatically transitioning the apparatus between the open position and the closed position.

In some embodiments, the interior chamber has a volume of less than one liter.

In some embodiments, the interior chamber has a volume less than one liter and a sample capacity of up to four microscope slides.

In some embodiments, the interior chamber may have a volume and may have a sample area at or less than a ratio of 1:7500 liters to square millimeters.

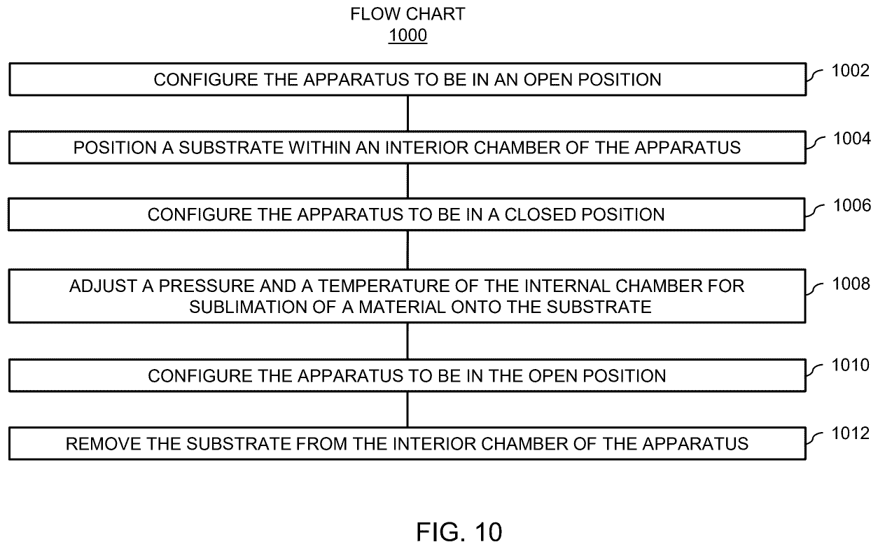

FIG. 10 depicts a flowchart 1000 illustrating a method of using the apparatus of using the previously described broader apparatus in accordance with embodiments of the present disclosure.

In step 1002, the method includes configuring the apparatus to be in an open position.

In step 1004, the method further includes positioning a substrate within an interior chamber of the apparatus.

In step 1006, the method further includes configuring the apparatus to be in a closed position with the substrate within the interior chamber.

In step 1008, the method further includes adjusting a pressure and a temperature of the interior chamber for sublimation of a material onto the substrate.

In step 1010, the method further includes configuring the apparatus to be in the open position.

In step 1012, the method further includes removing the substrate from the interior chamber of the apparatus.

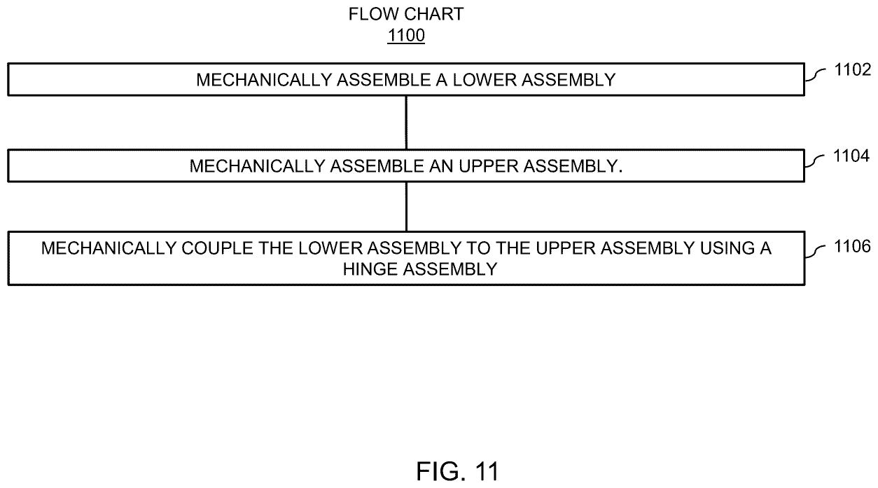

FIG. 11 depicts a flowchart 1100 illustrating a method for manufacturing the apparatus of the previously described broader apparatus in accordance with embodiments of the present disclosure. The apparatus is configured for allowing a substrate to be positioned within an interior chamber when in an open position, facilitating deposition of a material onto the substrate via sublimation when in a closed position, and allowing removal of the substrate with the material when returned to the open position.

In step 1102, the method includes mechanically assembling a lower assembly.

In step 1104, the method further includes mechanically assembling an upper assembly.

In step 1106, the method further includes mechanically coupling the lower assembly to the upper assembly using a hinge assembly.

In general, the device described herein provides many advantages for sublimation for materials onto a substrate. These include but are not limited to (1) a heater that is positioned within the vacuum and suspended to reduce heat transfer and loss to assembly (2) a ceramic heating capability in excess of 300 degrees, (3) a heat exchange core positioned to insulate the cooling from the rest of the device assembly and compatible with sub-zero coolants (4) a vacuum inlet positioned towards the bottom of the device, and (5) a diffusing plate to distribute vacuum flow as well as retain the heater in position against positioning screws, and (6) a funnel to direct matrix from the heat source to the samples.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. An apparatus for providing sublimation, the apparatus comprises:
a lower assembly;
an upper assembly;
a hinge assembly mechanically coupling the lower assembly to the upper assembly, wherein the apparatus is configured for:
allowing a substrate to be positioned within an interior chamber when in an open position;
facilitating deposition of a material onto the substrate via sublimation when in a closed position; and
allowing removal of the substrate with the material when returned to the open position.

2. The apparatus of claim 1, wherein the substrate is used in sample preparation for mass spectrometry imaging.

3. The apparatus of claim 1, wherein the lower assembly comprises a vacuum inlet configured for attachment to a vacuum pump.

4. The apparatus of claim 3, wherein the lower assembly further comprises a heat source electrically coupled via an electrical interconnect.

5. The apparatus of claim 4, wherein the upper assembly is configured to provide an internal chamber when in the closed position and comprises a sample holder.

6. The apparatus of claim 5, wherein the internal chamber is approximately a shape of a cylinder.

7. The apparatus of claim 5, wherein the internal chamber is approximately a shape of at least one of a prism, a sphere, and a cone.

8. The apparatus of claim 5, wherein the sample holder is configured to hold a plurality of samples.

9. The apparatus of claim 5, where samples are secured directly to a heat exchange core.

10. The apparatus of claim 9, wherein a magnetic mask is used to secure the samples to the heat exchange core.

11. The apparatus of claim 5, wherein the upper assembly further comprises a heat exchange core.

12. The apparatus of claim 11, wherein the heat exchange core is an isolated solid metal block extending from the internal chamber to an exterior of the upper assembly and acts as a heat sink when cooled with various coolants.

13. The apparatus of claim 12, wherein the heat exchange core is configured to be thermally coupled with a thermoelectric cooler.

14. The apparatus of claim 13, wherein the heat exchange core is configured to be thermally coupled with a liquid coolant, allowing cold temperatures below zero Celsius.

15. The apparatus of claim 14 wherein the liquid coolant can cool the heat exchange core to temperatures below negative 60 Celsius.

16. The apparatus of claim 5, wherein a removeable funnel is positioned inside the interior chamber to direct matrix particle cloud evenly towards a sample.

17. The apparatus of claim 16, wherein the removeable funnel comprises at least one of a polymer resin and other insulative high heat plastics material onto which allow matrix crystals to form less quickly than on colder metal surfaces.

18. The apparatus of claim 5, wherein the lower assembly further comprises a removeable patterned template for holding a substance for sublimation.

19. The apparatus of claim 5, wherein the lower assembly further comprises a direct contact plate for holding a substance for sublimation.

20. The apparatus of claim 19, wherein the direct contact plate has a patterned surface to promote even matrix distribution.

21. The apparatus of claim 19, wherein the direct contact plate is in direct contact with the heat source for holding matrix to be heated via the heat source during sublimation.

22. The apparatus of claim 5, wherein the heat source is an infrared heater configured to heat the interior chamber through a non-metallic porthole.

23. The apparatus of claim 5, wherein the heat source is a ceramic heater configured to heat the interior chamber to a temperature of at least 300 degrees Celsius.

24. The apparatus of claim 5, wherein the heat source is configured to achieve a temperature setpoint in less than 120 seconds.

25. The apparatus of claim 1, wherein the hinge assembly comprises a motor mechanism for automatically transitioning the apparatus between the open position and the closed position.

26. The apparatus of claim 1, wherein the interior chamber has a volume less than one liter and a sample capacity of up to four microscope slides.

27. The apparatus of claim 1, wherein the interior chamber has a volume and sample area has at or less than a ratio of 1:7500 liters to square millimeters.

28. A method of operating an apparatus for providing sublimation, the method comprising:
configuring the apparatus to be in an open position;
positioning a substrate within an interior chamber of the apparatus;
configuring the apparatus to be in a closed position; and
adjusting a pressure and temperatures of the interior chamber for sublimation of a material onto the substrate;
configuring the apparatus to be in the open position; and
removing the substrate from the interior chamber of the apparatus.

29. A method of manufacturing an apparatus configured for sublimation, the method comprising:
mechanically assembling a lower assembly;
mechanically assembling an upper assembly; and
mechanically coupling the lower assembly to the upper assembly using a hinge assembly, wherein the apparatus is configured for:
allowing a substrate to be positioned within an interior chamber when in an open position;
facilitating deposition of a material onto the substrate via sublimation when in a closed position; and
allowing removal of the substrate with the material when returned to the open position.
